(19) United States
(12) Patent Application Publication
(10) Pub. No.: US 2009/0035083 A1
(43) Pub. Date: Feb. 5, 2009

(54) DOUBLE TIPPED DIAMOND DRILL BIT

(76) Inventor: David T. Hunter, Bedford, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 12/184,708

(22) Filed: Aug. 1, 2008

Related U.S. Application Data
(60) Provisional application No. 60/953,792, filed on Aug. 3, 2007.

(51) Int. Cl. B27G 15/00

(52) U.S. Cl. 408/214

(57) ABSTRACT

The present invention is a drill bit with a generally cylindrical bit body. The body of the drill bit has a starter tip region adapted to be releasably secured to a drill spindle. The starter tip comprises a diamond or diamond coated starter tip. There is a drill tip disposed at an opposite end from the starter tip and extends generally outward. The drill tip has two or more cutting edges with a surface and two or more helical grooves. Each of the cutting edges has a layer of diamond crystals on its surface.

### TECHNICAL FIELD

The present invention relates to drill bits and more particularly, relates to double tipped diamond drill bits for ceramic or porcelain tile.

### BACKGROUND INFORMATION

Drill bits are commonly used to drill into a wide variety of surfaces. Drilling into ceramic or porcelain tile surfaces is particularly difficult, costly, and time consuming. Currently, carbide drill bits and diamond coated core drill bits have been used for drilling into these surfaces. However, these drill bits are inefficient, function slowly, crack the ceramic or porcelain tile, and do not last very long. There is also a tremendous amount of material generated during the drilling process that quickly dulls the carbide bit. As a result, drilling through hard services is a slow and tedious process that often results in damage to the drilling surface due to excessive force exerted by the person operating the drill. Therefore, traditional carbide drill bits must be replaced often increasing material and labor costs.

The diamond coated core drills overcome some of the disadvantages of the carbide drill bit, however, they suffer from several known disadvantages. For example, the diamond coated core drills generally require the use of heavy, expensive, and bulky tools such as a drill press. Moreover, the blunt cutting surfaces of the diamond coated core drills makes them prone to “walking” across the surface being drilled unless used with a drill press or a pilot hole. These core drills are not practical for drilling small diameter holes because of their bulky design and overall size.

Accordingly, what is needed is an improved drill bit that is economical and capable of withstanding the forces generated while drilling through hard services such as porcelain, ceramic, and stone. The improved drill bit should be capable of repeatedly withstanding such forces without the need to be constantly replaced. Additionally, the improved drill bit should be capable of drilling small and large diameter holes, and should not require expensive or bulky tools.

### SUMMARY

The present invention is a drill bit that has a generally cylindrical bit body. The body has a first end region that is adapted to be releasably secured to a drill spindle and an opposite, second end region for drilling into a material. There is a starter tip disposed along a longitudinal centerline of the bit body and extending generally outward from the first end. In the preferred embodiment, the starter tip is comprised of a solid, grown synthetic diamond piece bonded to the end of the steel shank of the drill bit. Alternatively, the starter tip may comprise a group of small diamonds or diamond particles disposed about or impregnated into at least a portion of the exterior surface of the starter tip. These particles are preferably a number of diamonds bonded or impregnated onto the starter tip.

There is a drill tip disposed along a longitudinal centerline of the bit body and extending generally outward from the second end of the drill. This drill tip has two or more cutting edges with an exterior surface having two or more helical grooves. Each of the cutting edges has a layer of solid diamonds bonded onto its surface. The layer of solid diamond is preferably of a polycrystalline diamond material.

### BRIEF DESCRIPTION OF THE DRAWINGS

These and other features and advantages of the present invention will be better understood by reading the following detailed description, taken together with the drawings wherein:

FIG. 1 is a perspective view of the double diamond drill bit according to the present invention; and

FIG. 2 is an end view of the double diamond drill bit according to the present invention.

### DETAILED DESCRIPTION OF THE PREFERRED EMBODIMENTS

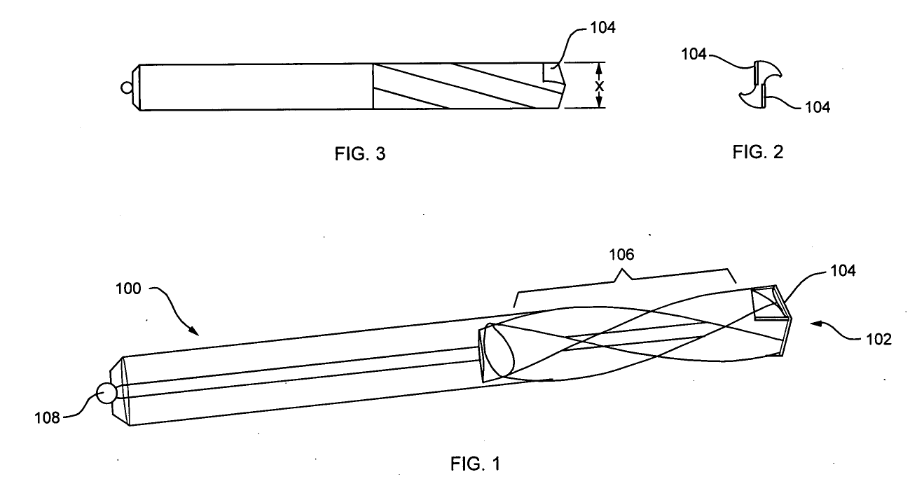

The present invention is a double tipped diamond twist drill 100, FIG. 1, which includes a starting tip 108 at the first end and a drilling tip 102 on and at the second end. The drill is preferably of the twist type having two or more cutting edges 104 and having helical grooves 106. These helical grooves 106 provide for the passage of cutting chips and for the passage of coolant along the cutting edges. Typically, the twist-type drill is used for originating holes or enlarging existing holes. The twist drill body is produced of heat-treated alloy/tool steel. The drill bit of the present invention preferably includes a drill point angle of about 120 degrees, a relief angle of about 30 degrees, and a helix angle of about 28 degrees.

The cutting edges 104 of the drilling tip, FIG. 2, have a solid bonded layer of Polycrystalline Diamond (PCD). PCD is a material consisting of natural or synthetic diamond crystals bonded together under high pressure at elevated temperatures. These diamond tip drill bits typically cut ten times faster than carbide drills and diamond coated core drills. The diamond tipped drill bit drills cleanly and does not crack the ceramic or porcelain tile. It also has an extended life over the existing products. Double tipped diamond drills also reduce tangential, axial, and radial cutting forces.

In the ceramic and porcelain tile industry, it is known that if you make a small scratch, nick, or dimple on the surface of the ceramic or porcelain tile prior to drilling, the drill bit will perform much better. This means that the drill runs faster and cleaner without “walking” or cracking the tile, thereby lasting for a longer period of time. The scratch, nick, or dimple is known as a “starting hole.” The double tipped drill of the present invention has a starting tip 108 that is located opposite from the drill tip 102 and includes a solid section of Chemical Vapor Deposition Diamond (CVD) material. CVD is a diamond material that is grown by a high temperature atmosphere controlled process. A chemical reaction is induced to deposit (grow) the diamond material that is then bonded to the steel shank of the drill bit. This starter tip 108 is preferably comprised of the CVD diamond material is used to create the “starting hole.” Once installed in a hand drill, the CVD diamond section of the starting tip 108 penetrates the hard surface of the ceramic or porcelain tile creating a small starting hole. The drill penetrates to a depth range of about 0.03 to 0.04 in. and creates an opening of about 0.06 to 0.08 in. wide. After the ceramic or porcelain has the “starting hole,” a user reverses the drill bit in the hand drill and efficiently and effortlessly drills a hole. This two-step process utilizing only one drill bit creates a very effective system for drilling many types of ceramic and porcelain tile. Alternatively, the starter tip 108 may comprise a group of small diamonds or diamond particles bonded to or impregnated into at least a portion of the exterior surface of a starter tip comprised of other material such as carbide or the like. These particles are preferably a number of diamonds bonded or impregnated onto the starter tip.

In the preferred embodiment, the drill 100 is approximately 2.25 inches long, tip to tip, with a drill flute length of approximately 1.00 inch. The starter tip 108 has a preferred width of 0.075 inches and a depth of 0.060 inches.

Accordingly, the present invention provides a novel, two-ended drill; wherein one end is configured to create a small starting hole in the material to be drilled, while the second end is a more conventional type of drill used to drill a hole in a substrate material.

Modifications and substitutions by one of ordinary skill in the art are considered to be within the scope of the present invention, which is not to be limited except by the allowed claims and their legal equivalents.

The invention claimed is:

1. A drill bit comprising:
a generally cylindrical bit body having a first end region adapted to be releasably secured to a drill spindle and a second end region disposed generally opposite said first end region;
a starter tip disposed along a longitudinal centerline of said generally cylindrical bit body and extending generally outwardly from said first end region, said starter tip comprising one or more diamond particles disposed on or about at least a portion of an exterior surface of said starter tip; and
a drill tip disposed along a longitudinal centerline of said generally cylindrical bit body and extending generally outwardly from said second end region, said drill tip having two or more cutting edges, each cutting edge including a cutting surface and a plurality of helical grooves.

2. The drill bit of claim 1 each of said cutting edges has a layer of diamond crystals on said surface.

3. The drill bit of claim 1 further comprising a fluted region disposed at said drill tip, said fluted region extending less than one-half a length of said bit body.

4. The drill bit of claim 2, wherein said layer of diamond crystals are a polycrystalline diamond material.

5. The drill bit of claim 2, wherein said diamond particles are a solid section of chemical vapor deposition diamond.

6. The drill bit of claim 1 wherein said drill cutting edges include a drill point angle of about 120 degrees.

7. The drill bit of claim 1 wherein said drill tip further comprises a relief angle of about 30 degrees.

8. The drill bit of claim 1 wherein said drill tip further comprises a helix angle of about 28 degrees.

9. A drill bit comprising:
a generally cylindrical bit body having a first end region adapted to be releasably secured to a drill spindle and a second end region disposed generally opposite said first end region;
a starter tip disposed along a longitudinal centerline of said generally cylindrical bit body and extending generally outwardly from said first end region, said starter tip comprising a Chemical Vapor Deposition diamond bonded to first end region of said generally cylindrical bit body; and
a drill tip disposed along a longitudinal centerline of said generally cylindrical bit body and extending generally outwardly from said second end region, said drill tip having two or more cutting edges, each cutting edge including a cutting surface and a plurality of helical grooves.
